(19) United States
(12) Patent Application Publication
(10) Pub. No.: US 2022/0076222 A1
(43) Pub. Date: Mar. 10, 2022

(54) System and Method for Usage-Based Payment Processing

(71) Applicant: Monetimze LLC, Plano, TX (US)

(72) Inventor: Clayton K. Redmon, Grand Prairie, TX (US)

(21) Appl. No.: 17/468,646

(22) Filed: Sep. 7, 2021

Related U.S. Application Data
(60) Provisional application No. 63/075,767, filed on Sep. 8, 2020.
(60) Provisional application No. 63/144,455, filed on Feb. 1, 2021.

(51) Int. Cl. G06Q 20/12; G06Q 30/04; G06Q 20/02; G06F 1/14

(52) U.S. Cl. CPC G06Q 20/127; G06F 1/14; G06Q 20/027; G06Q 30/04

(57) ABSTRACT

An on-demand payment method for a timed session includes initiating a timed session between a first computing device and at least one second computing device, initiating a timer on the second computing device in response to a trigger, and tracking elapsed time of the timed session associated with the second computing device, detecting termination of the timed session at the second computing device and stopping the timer, automatically determining an invoice amount based at least in part on the value of the timer, automatically communicating the invoice amount and payment information to a payment gateway for payment and settlement of the invoice amount, and automatically receiving payment for the invoiced amount in an account.

### RELATED APPLICATIONS

This U.S. Non-Provisional Patent Applications claims the benefit of U.S. Provisional Patent Application No. 63/075,767 filed on Sep. 8, 2020, and 63/144,455 filed on Feb. 1, 2021.

### FIELD

This disclosure relates generally to payment processing, and in particular to a system and method for usage or time-based payment processing.

### BRIEF DESCRIPTION OF THE DRAWINGS

FIG. 1 is a simplified block diagram of a system and method for time-based payment processing according to the teachings of the present disclosure;

FIG. 2 is a simplified flowchart of an embodiment of a system and method for time-based payment processing according to the teachings of the present disclosure; and

FIG. 3 is a simplified flow diagram of an embodiment of a system and method for time-based payment processing according to the teachings of the present disclosure.

### DETAILED DESCRIPTION

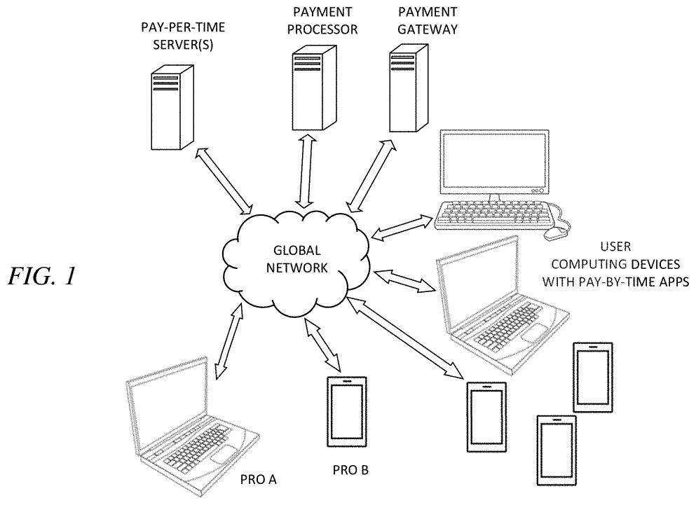

FIG. 1 is a simplified block diagram of a system and method for on-demand time-based (also thought of as usage-based) payment processing according to the teachings of the present disclosure. The “professional” users (pros or pro users) and application users (app users or non-pro users) may use computing devices (e.g., mobile phone, tablet computer, laptop computer, desktop computer) with the time-based payment app running on their chosen computing platforms. The pros may use a pro version of the app and other users may use a non-pro version of the app. Alternatively, both pro users and non-pro users may use the same app but they are differentiated as payee, which is the party receiving time-based payment, and payor, which is the party making time-based payment. The term “time-based payment” means that the amount of the payment is determined or calculated based on some aspect of the elapsed time associated with the interaction between the pro user and the app user.

The pro version of the app enables the pro to engage one or more users in a timed session who are using the non-pro version of the app executing on their respective computing devices, and the pro may charge and receive a payment or a fee from each of the users based at least in part on the amount of elapsed time of the timed session(s). The pro's timed session with each user may or may not be simultaneous and synchronous with other users. The pro's timed session with each user may be live (i.e., real-time) or pre-recorded. The timed session may include conveyance or transmission of audio data, video data, and still image data. The pro and a user may be physically distant and spaced apart from one another, or they may co-exist in the same physical space.

The time-based payment application program described herein may be part of or independent of an on-demand real-time consultation platform that enable users to request and receive consultation from the pros. For example, the consultation platform may enable one or more users to each request a timed session from a lawyer, physician, psychiatrist, psychologist, nutritionist, financial adviser, accountant, therapist, coach, tutor, teacher, consultant, exercise coach, guru, handyman, mechanic, plumber, repairman, babysitter, dog-walker, dog trainer, or another service provider. The time-based payment app enables a pro to charge each user a fee for the timed session(s) based on a function of the time duration of the session(s). For example, one or more users may engage a particular pro in a timed session for twenty minutes. The time-based payment app automatically issues an invoice for a fee whose amount is based on the duration, twenty minutes, of the session, and the user's device automatically communicates the invoice and the user's payment details with a payment gateway to submit payment to the pro. The time-based payment service may additionally charge a processing fee based either on the elapsed time of the session or a per-transaction amount.

In another example, a pro may charge multiple users a fee based on the timed duration of a single session. For example, lecturers, consultants, coaches, motivational speakers, youtubers, etc. may charge their audience for a timed live (real-time) or pre-recorded video/audio/communication session. The users who become engaged in the timed session may pay a fee amount based on each individual's connection time to the session or a pre-negotiated flat fee. Users may independently pause their timers and thus pause their connection time periods, and the session fees may reflect the total connection time when the users are actually receiving audio/visual information. Alternatively, the fee charged to each user may take into account of the entire time the user is connected to the session regardless of the paused time periods.

In yet another example, pro users may be “creators” in a social platform such as CLUBHOUSE, and users may make payment to the pro users based on the amount of time they spend in the rooms. In this embodiment, the time duration is determined based on the user entering a particular room occupied by the pro user. When a user enters a room, their user app timer is triggered to begin to keep time. When the user leaves a room, their user app automatically determines the amount of time that user stayed in the room, automatically calculates a payment amount based on the elapsed time and the billing rate set by the pro user, and automatically forwards the user's payment information to the payment gateway.

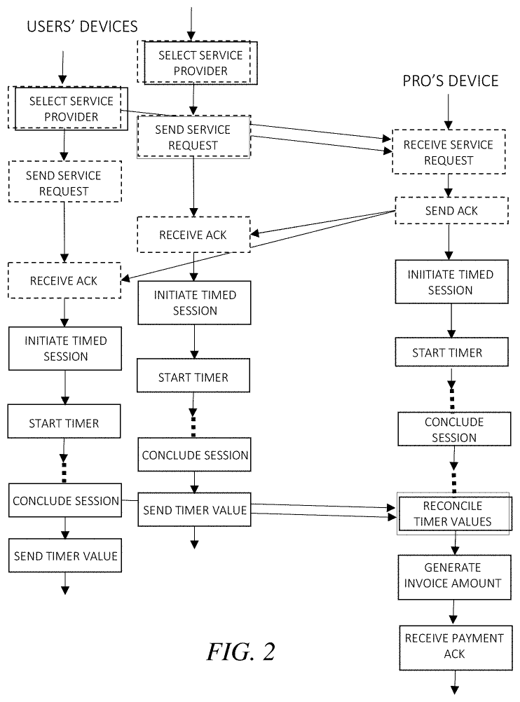

FIG. 2 is a simplified flowchart of an embodiment of a system and method for time-based payment processing. Users, using computing devices, are able to specify the type of service desired, and select a service provider or pro, who may be, for example, a youtuber doing a live (real-time) makeup application demonstration. The users' devices transmit service requests to the registered device of the selected pro user. The requests may be transmitted via the time-based payment server. The pro's computing device, upon receipt of the requests, enables the pro to respond or acknowledge the request, which is sent to the requesting users' devices. The pro and the audience users may then begin the timed live session, which may (or may not) include a videoconferencing capability to enable the two users to see each other and their environments. At the initiation of the timed session, the pro's device and the users' devices each begins a timer. When the timed session ends, the users' devices transmit the timer values to the pro user's device, which reconciles the timer values to determine a timed session duration. Alternatively, the session duration may default to either the pro's timer value or each user's timer value. An invoice amount is then automatically determined or computed for each user based on the duration of the session. For example, if the timed session duration is twenty minutes, this is multiplied by the pro user's billing rate to determine the invoice amount. The invoice value may be based entirely on the pro's timer or the user's timer. The pro may indicate their preference in how the invoice value is determined. Alternatively, the time-based payment server may perform the task of reconciling the different timer values between the pro and the user, having received the timer values from both user devices.

In an alternate embodiment, as shown by solid line blocks in FIG. 2, the time-based payment app running on the users' computing devices may simply start the timed session upon initiation from the users, keep track of the session duration, reconcile time duration kept by both devices, automatically generate an invoice for the timed session, and automatically make and receive payment for the timed session by communicating the payment details to a payment gateway.

In the CLUBHOUSE example, the time-based payment app running on the users' computing devices may simply start the timer upon entering a pro/creator's room, and keeps track of the duration that the user spends inside that room. Upon exiting the room, the user's app automatically determines the elapsed time and automatically communicate the payment details to a payment gateway for making a payment to the pro user/creator.

Examples of existing payment gateways include Stripe, Paypal, Square, SecurePay, Worldpay, 2Checkout, Authorize.net, and Amazon.

A payment gateway is a hardware and software complex that automates the process of accepting payments on the Internet. A payment gateway would check the validity of the credit card, debit card, bank account number, or other forms of payment tendered for payment, determine the issuing bank, encrypt the credentials associated with the payment method, inform a merchant bank to initiate a funds transfer, and respond to the service provider regarding the payment. The payment gateway would securely transfer the payment information to the card network for further processing. The payment gateways allow merchants to accept credit card payments by connecting payment processors (the service charging the card) and merchant account providers (the service providing your payment systems). The payment gateway provides a payment service that processes credit cards online through an e-commerce site.

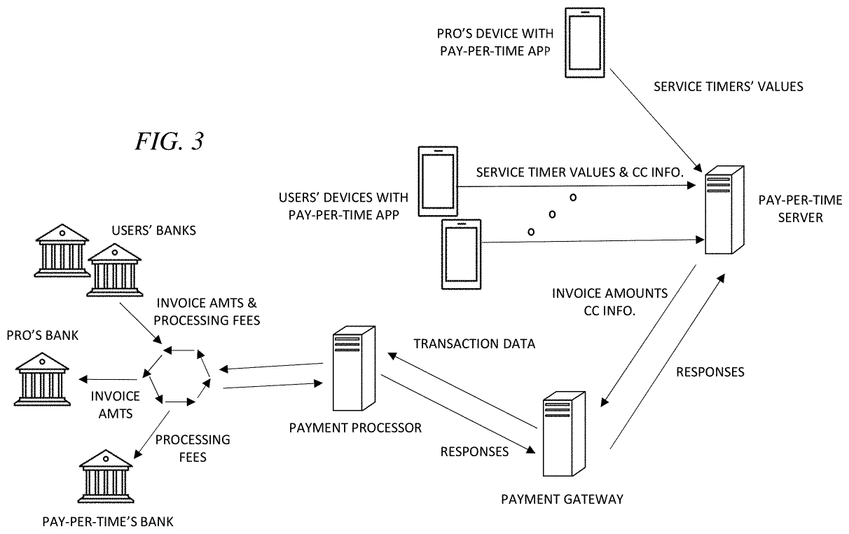

FIG. 3 is a simplified flow diagram of an embodiment of a system and method for on-demand time-based payment processing. At the conclusion of a timed session for services provided by a pro to multiple users, the pro's and the users' devices (each running the time-based payment app) send their respective timer values to the time-based payment server. The time-based payment server reconciles the time devoted to the provision of the service (e.g., timed live or non-live pre-recorded session), and determines an invoice amount. Alternatively, the users' devices send the timer values to the pro's device, which makes a determination for the elapsed time for the session for each user. The elapse time for the session may be determined by choosing the shorter, longer, or average elapsed time period for the session, based on the pro's timer value and each user's timer value. Alternatively, payment amount may be determined based only on the timer value of the user's timer. A payment in an amount based on the reconciled elapsed time of the timed session is now due to the pro. The pro and each user's devices/apps receive the invoice amount from the time-based payment server so that the users are notified of the charge for the timed session. Additionally, a service charge of a certain percentage or a per-transaction amount may be added to the invoice amount. Each user's credit card information and/or banking information, and the invoice amount are transmitted by the time-based payment server to a payment gateway.

The payment gateway may allow transaction data to be sent directly from the user's device to the payment gateway, bypassing the time-based payment server, thus reducing the time-based payment server's Payment Card Industry Data Security Standard (PCI DSS) compliance obligations. The time-based payment server forwards the transaction details to the payment gateway. This is an encrypted connection (SSL) to the payment server hosted by the payment gateway. The payment gateway converts the message from XML to ISO 8583 or a variant message format (one understood by EFT Switches) and then forwards the transaction information to the payment processor used by user A's acquiring bank.

The payment processor forwards the transaction information to the card association (I.e.: Visa/MasterCard/American Express). If an American Express or Discover Card was used, then the card association also acts as the issuing bank and directly provides a response of approved or declined to the payment gateway. Otherwise (e.g.: MasterCard or Visa card was used), the card association routes the transaction to the correct card issuing bank.

The credit card issuing bank receives the authorization request, verifies the credit or debit available and then sends a response back to the payment processor (via the same process as the request for authorization) with a response code (i.e., approved or denied). In addition to communicating the result of the authorization request, the response code is also used to define the reason why the transaction failed (e.g., insufficient funds or bank link not available). The payment processor then forwards the authorization response to the payment gateway. The payment gateway receives the response and forwards it onto the time-based payment server, which is then relayed back to the pro and each user. A clearing and settlement process occurs between the banking institutions to make the proper payments according to the authorized amounts.

The time-based payment platform described herein includes a software development kit or SDK that allows other third party software developers to easily incorporate the time-based functionality into third party software so that this functionality can provide usage or time-based payment processing to other applications or use cases. The time-based payment SDK includes a plug-and-play library with APIs (application programming interfaces) that enable third party developers to more easily build time-based payment solutions to interface with payment gateways and other devices using a variety of programming languages on multiple platforms.

It should be noted that all of the steps of the process, other than user input, are performed by the appropriate computing devices and that these steps cannot be processed by human mental processes. The platform and method described herein provide an improvement in the performance of the computing devices in processing payment transactions between parties.

A time-based payment software development kit comprising computer-readable code configured to perform the steps of: initiating a real-time session at a first computing device with at least one second computing device; initiating a first timer on the first computing device and track elapsed time of the real-time session; detecting termination of the real-time session at the second computing device and stopping the second timer; receiving a value of the second timer from the second computing device; comparing values of the first and second timers; determining an invoice amount based at least in part on the values of the first and second timers; and automatically communicating the invoice amount and payment information to a payment gateway for payment and settlement of the invoice amount and a processing fee.

An on-demand payment method for a timed session comprising: initiating a timed session between a first computing device and a second computing device; initiating a first timer on the first computing device and track elapsed time of the timed session; initiating a second timer on the second computing device and track elapsed time of the timed session; detecting termination of the timed session at the first computing device and stopping the first timer; detecting termination of the timed session at the second computing device and stopping the second timer; comparing values of the first and second timers; automatically determining an invoice amount based at least in part on the values of the first and second timers; automatically communicating the invoice amount and payment information to a payment gateway for payment and settlement of the invoice amount and a processing fee; and receiving payment for the invoiced amount and processing fee.

A payment method comprising: initiating a real-time session at a first computing device with a second computing device; initiating a first timer on the first computing device and track elapsed time of the real-time session; detecting termination of the real-time session and receiving a value of the second timer from the second computing device; determining an invoice amount based at least in part on the value of the second timer; and automatically communicating the invoice amount and payment information to a payment gateway for payment and settlement of the invoice amount.

A payment method comprising: receiving a request for real-time service from at least one first computing device; transmitting information relating to service provider options to the at least one first computing device; receiving a selection of a service provider; transmitting a service request to a second computing device; enabling a real-time communication session between the first and second computing devices; receiving first and second timer values from the first and second computing devices; automatically determining an invoice amount based at least in part on the values of the first and second timers; and automatically communicating the invoice amount and payment information to a payment gateway for payment and settlement of the invoice amount and a processing fee.

A time-based payment app comprising computer-readable code configured to perform the steps of: initiating a real-time session at a first computing device with at least one second computing device; initiating a first timer on the first computing device and track elapsed time of the real-time session; detecting termination of the real-time session at the second computing device and stopping the second timer; receiving a value of the second timer from the second computing device; comparing values of the first and second timers; determining an invoice amount based at least in part on the values of the first and second timers; and automatically communicating the invoice amount and payment information to a payment gateway for payment and settlement of the invoice amount and a processing fee.

The features of the present invention which are believed to be novel are set forth below with particularity in the appended claims. However, modifications, variations, and changes to the exemplary embodiments described above will be apparent to those skilled in the art, and the system and method for time-based payment processing described herein thus encompasses such modifications, variations, and changes and are not limited to the specific embodiments described herein.

What is claimed is:

1. An on-demand payment method for a timed session comprising:
initiating a timed session between a first computing device and a plurality of second computing devices;
initiating a first timer on the first computing device for each of the plurality of second computing devices and track elapsed time of the timed session associated with each of the plurality of second computing devices;
initiating a second timer on each of the plurality of second computing devices and track elapsed time of the timed session associated with each of the plurality of second computing devices;
detecting termination of the timed session at the first computing device and stopping the first timer;
detecting termination of the timed session at a particular one of the second computing devices and stopping the second timer associated with the particular second computing device;
comparing values of the first and second timers;
automatically determining an invoice amount based at least in part on the values of the first and second timers;
automatically communicating the invoice amount and payment information to a payment gateway for payment and settlement of the invoice amount and a processing fee; and
automatically receiving payment for the invoiced amount in a first account, and automatically receiving payment for the processing fee in a second account.

2. The method of claim 1, further comprising:
receiving a pause input on a particular device from a user; and
pausing the timer on the particular device.

3. The method of claim 1, wherein automatically determining an invoice amount is based on the first timer value despite the second timer value.

4. The method of claim 1, wherein automatically determining an invoice amount is based on the second timer value despite the first timer value.

5. A time-based payment software development kit comprising computer-readable code configured to perform the steps of:
initiating a real-time session at a first computing device with at least one second computing device;
initiating a first timer on the first computing device and track elapsed time of the real-time session;
detecting termination of the real-time session at the second computing device and stopping the second timer;
receiving a value of the second timer from the second computing device;
comparing values of the first and second timers; determining an invoice amount based at least in part on the values of the first and second timers; and
automatically communicating the invoice amount and payment information to a payment gateway for payment and settlement of the invoice amount and a processing fee.

6. An on-demand payment method for a timed session comprising:
automatically initiating a timed session between a first computing device and at least one second computing device in response to a predetermined interaction between the first and second computing devices;
automatically initiating a timer on the second computing device in response to the initiation of the timed session, and tracking elapsed time of the timed session associated with the second computing device;
automatically detecting termination of the timed session at the second computing device and stopping the timer;
automatically determining an invoice amount based at least in part on the value of the timer;
automatically communicating the invoice amount and payment information to a payment gateway for payment and settlement of the invoice amount; and
automatically receiving payment for the invoiced amount in an account.

7. The method of claim 6, further comprising automatically receiving payment for a processing fee in a second account.

8. The method of claim 6, wherein automatically initiating a timed session is in response to the second computing device receiving audio/visual data from the first computing device.

9. The method of claim 6, wherein automatically initiating a timed session is in response to an interaction selected from the group consisting of a live communication session and a pre-recorded audio/video/pictorial session.
